(19) United States
(12) Patent Application Publication
(10) Pub. No.: US 2020/0122402 A1
(43) Pub. Date: Apr. 23, 2020

(54) THREE DIMENSIONAL PRINTING METHOD AND THREE DIMENSIONAL PRINTING APPARATUS

(71) Applicants: XYZprinting, Inc., New Tapei City (TW); Kinpo Electronics, Inc., New Tapei City (TW)

(72) Inventors: Shih-Chi Yang, New Taipei City (TW); Yao-Jen Kuo, New Taipei City (TW); Shau-An Tsai, New Taipei City (TW)

(73) Assignees: XYZprinting, Inc., New Taipei City (TW); Kinpo Electronics, Inc., New Taipei City (TW)

(21) Appl. No.: 16/382,207

(22) Filed: Apr. 12, 2019

(30) Foreign Application Priority Data
Oct. 17, 2018 (CN) 201811208545.6

(51) Int. Cl. B29C 64/393; B33Y 10/00; B33Y 30/00; B33Y 50/02; B29C 64/10; B29C 64/40

(52) U.S. Cl. CPC B29C 64/393; B33Y 10/00; B33Y 30/00; B29C 64/245; B29C 64/10; B29C 64/40; B33Y 50/02

(57) ABSTRACT

A three dimensional (3D) printing method and a 3D printing apparatus are provided. The 3D printing method includes: performing a voxelization operation on a space including a 3D model to obtain a plurality of voxels corresponding to the space; selecting a first voxel of the voxels including a first supporting point of supporting points; determining a first merge point of a plurality of merge points according to the first voxel, wherein the first merge point is located at a second voxel of the voxels; printing a first supporting member of supporting members according to the first supporting point and the first merge point.

### CROSS-REFERENCE TO RELATED APPLICATION

This application claims the priority benefit of Chinese application serial no. 201811208545.6, filed on Oct. 17, 2018. The entirety of the above-mentioned patent application is hereby incorporated by reference herein and made a part of this specification.

### BACKGROUND

### Technical Field

The disclosure relates to a printing method. More particularly, the disclosure relates to a three dimensional printing method and a three dimensional printing apparatus.

### Description of Related Art

In three dimensional (3D) printing technology, when a 3D model to be formed is present in a suspension region (that is, a space is present between the space where the 3D model is present and a platform), a 3D printing apparatus is required to simultaneously print a supporting structure between the suspension region and the platform. The supporting structure consists of a number of supporting members and supporting points, so that the 3D model is prevented from being structurally affected by stress concentration or deformation caused by the suspension region.

In the 3D model, a supporting head is grown first most of the time from the supporting points on the surface of the 3D model according to a specific angle corresponding to the surface of the 3D model, and then the supporting members are grown through the supporting head. It is worth noting that in the related art, when the supporting head is grown according to the surface of the 3D model, the 3D printing apparatus has less flexibility in selecting the angle of the supporting head. As such, in the growing process, the supporting head may easily be in contact with the 3D model. In addition, when the supporting head is grown according to the specific angle and the included angle between the specific angle and the normal direction of the surface of the 3D model is excessively large, since the contact area between the supporting head and the surface of the 3D model is relatively large, the surface of the 3D model may easily be damaged.

From another perspective, the supporting members are connected to the model through at least one supporting tail in the related art. When one single supporting tail is used to enable the supporting members to be connected to the model, the supporting tail is usually required to have a larger diameter. Under such circumstances, when the supporting structure is required to be removed from the model, damage to the surface of the model caused by the supporting tail may be considerably great. In addition, when several supporting tails are used to allow the supporting members to be connected to the model, since these supporting tails are grown at positions close to the ends of the supporting members, contact angles at which these supporting tails are connected to the surface of the model are limited, so that a favorable contact angle may not be available.

A large amount of time is required to be consumed to determine the supporting members, so that operation time of the processor is further affected. Therefore, how to effectively optimize the technology of merging the supporting points and the supporting members and overcome the shortcomings of the supporting head and the supporting tails so as to increase the speed and quality of 3D printing is an important issue in this field.

### SUMMARY

The disclosure provides a three dimensional (3D) printing method and a 3D printing apparatus configured to print a 3D model having a suspension region.

In an embodiment of the disclosure, a 3D printing method for a 3D printing apparatus is provided. The 3D printing apparatus is configured to print a 3D model and at least one supporting member which is used to support the 3D model so that the 3D model is formed on a platform. The supporting member is connected to at least one supporting point corresponding to the 3D model. The 3D printing method includes following steps. A voxelization operation is performed on a space including a 3D model to obtain a plurality of voxels corresponding to the space. A first voxel of the voxels including a first supporting point of supporting points is selected. A first merge point of a plurality of merge points is determined according to the first voxel. The first merge point is located at a second voxel of the voxels. At least one first supporting member of supporting members is printed according to the first supporting point and the first merge point. The first supporting member has a first sub-supporting member and a second sub-supporting member. A first end of the first sub-supporting member is connected to the first merge point. A first end of the second sub-supporting member is connected to the first merge point, and a second end of the second sub-supporting member is connected to the first supporting point.

In an embodiment of the disclosure, a 3D printing apparatus including a platform, a print head, and a processor is provided. The print head is configured to print a 3D model and at least one supporting member which is used to support the 3D model on the platform. The supporting member is connected to at least one supporting point corresponding to the 3D model. The processor is configured to perform a voxelization operation on a space including the 3D model to obtain a plurality of voxels corresponding to the space. A first voxel of the voxels including a first supporting point of supporting points is selected. A first merge point of a plurality of merge points is determined according to the first voxel. The first merge point is located at a second voxel of the voxels. At least one first supporting member of supporting members is printed according to the first supporting point and the first merge point. The first supporting member has a first sub-supporting member and a second sub-supporting member. A first end of the first sub-supporting member is connected to the first merge point. A first end of the second sub-supporting member is connected to the first merge point, and a second end of the second sub-supporting member is connected to the first supporting point.

To sum up, in the 3D printing method and the 3D printing apparatus provided by the disclosure, voxelization is performed on the space including the 3D model by the processor, so that whether each of the voxels in the space is present in the 3D model is recorded, and other related information such as whether the supporting point of each of the voxels is connected to the 3D model or the platform is also recorded. In this way, in the disclosure, the supporting members may effectively keep away from the 3D model when the supporting members are grown according to the related information. Therefore, time for searching the growing paths is reduced, and 3D printing quality is further enhanced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a three dimensional (3D) printing apparatus according to an exemplary embodiment of the disclosure.

FIG. 2A is a schematic view illustrating a scenario of a 3D printing method according to an exemplary embodiment of the disclosure.

FIG. 2B is a schematic view illustrating a scenario of the 3D printing method according to another exemplary embodiment of the disclosure.

FIG. 2C is a schematic view illustrating a process of searching for a voxel having a merge point according to the embodiment of FIG. 2B.

FIG. 3 is a flow chart illustrating the 3D printing method according to an exemplary embodiment of the disclosure.

FIG. 4A is a schematic view illustrating a third sub-supporting member according to an exemplary embodiment of the disclosure.

FIG. 4B is a schematic view illustrating voxel distribution of the third sub-supporting member according to an exemplary embodiment of the disclosure.

FIG. 4C is a schematic view illustrating a process of searching for voxels of the third sub-supporting member according to an exemplary embodiment of the disclosure.

FIG. 5 is a flow chart illustrating the 3D printing method according to another exemplary embodiment of the disclosure.

FIG. 6A is a schematic view of a first-type supporting tail according to an exemplary embodiment of the disclosure.

FIG. 6B is a schematic view illustrating the first-type supporting tail according to another embodiment of the disclosure.

FIG. 7 is a simulation view illustrating a result of 3D printing according to an exemplary embodiment of the disclosure.

### DESCRIPTION OF THE EMBODIMENTS

Exemplary embodiments of the disclosure are explained in detail below with reference to the drawings. In addition, wherever possible, identical or similar reference numerals stand for identical or similar elements/components in the drawings and embodiments.

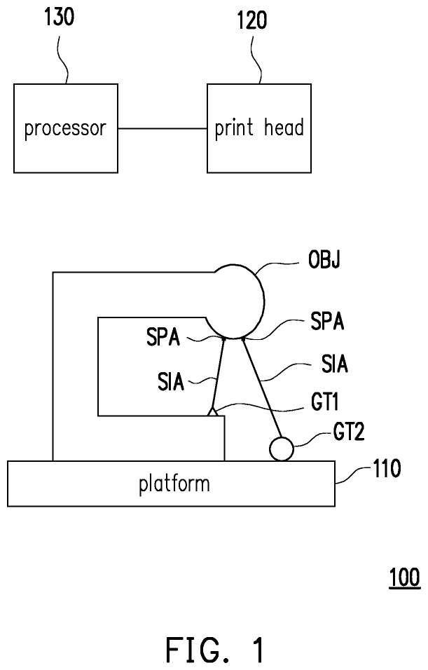

FIG. 1 is a schematic view illustrating a three dimensional (3D) printing apparatus according to an exemplary embodiment of the disclosure. With reference to FIG. 1, a 3D printing apparatus 100 includes a platform 110, a print head 120, and a processor 130. The print head 120 is coupled to the processor 130. The print head 120 is configured to print a 3D model OBJ and supporting members SIA supporting the 3D model OBJ on the platform 110. The supporting members SIA are located in a space (i.e., a suspension region) of the 3D model OBJ. Herein, the supporting members SIA are connected to the corresponding 3D model OBJ through supporting points SPA. Further, the supporting members SIA are connected to the 3D model OBJ and the platform 110 respectively through a first-type supporting tail GT1 and a second-type supporting tail GT2.

In this embodiment, the processor 130 may be controlled by an electronic apparatus (e.g., a notebook computer, a tablet computer, a desktop computer, or other computer apparatuses) featuring a computing function. A user may edit and process the 3D model OBJ of a 3D object through the electronic apparatus. Further, the user may transmit related parameters and information of the 3D model OBJ to the print head 120 through the processor 130, so as to instruct the print head 120 to print the 3D model OBJ and the supporting members SIA on the platform 110 according to the parameters and information.

The processor 130 of this embodiment may be, for example, a central processing unit (CPU) or may be a programmable microprocessor for general or special use, a digital signal processor (DSP), a programmable controller, an application specific integrated circuit (ASIC), a programmable logic device (PLD), other similar devices, or a combination of the foregoing devices and may be loaded to run a computer program, which is not limited by the disclosure.

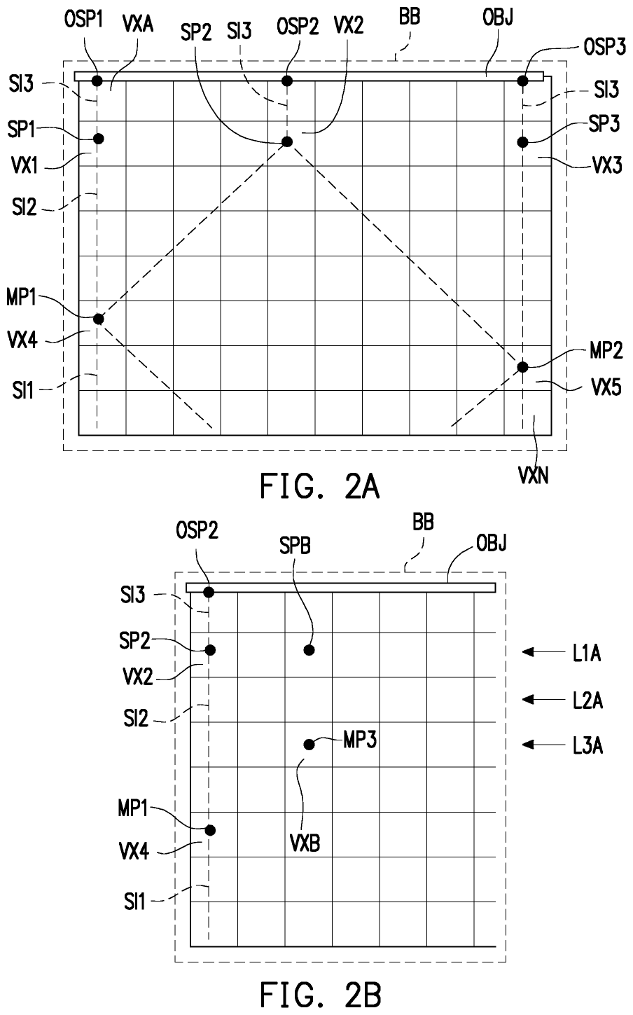

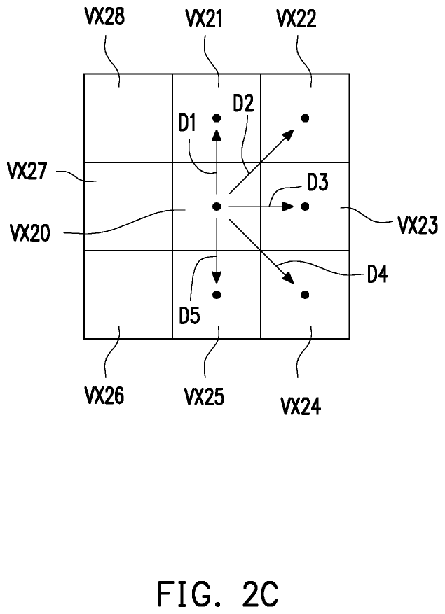

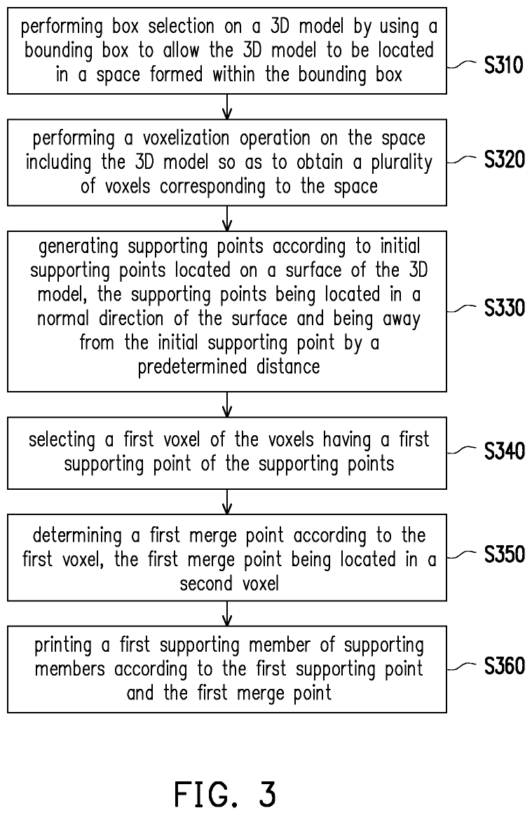

With reference to FIG. 1, FIG. 2A, and FIG. 3 together, FIG. 2A is a schematic view illustrating a scenario of a 3D printing method according to an exemplary embodiment of the disclosure. Besides, FIG. 3 is a flow chart illustrating the 3D printing method according to an exemplary embodiment of the disclosure. A 3D printing method of this embodiment is suited to the 3D printing apparatus 100 of FIG. 1. Steps of the 3D printing method of this embodiment are explained in detail hereinafter with reference to the components in the 3D printing apparatus 100. Note that in the embodiment of FIG. 2A of the disclosure, description is provided based on a side view in a three-dimensional space, and each of voxels is structurally formed in a 3D manner.

First, in step S310, the processor 130 may perform box selection on the 3D model OBJ by using a bounding box BB to allow the 3D model OBJ to be located in the space formed within the bounding box BB. Herein, in FIG. 2A, the space selected through box selection by the bounding box BB represents merely one supporting member SIA of the 3D model OBJ, and this portion of the supporting member SIA is served as the scenario of this embodiment for description.

In step S320, the processor 130 may perform a voxelization operation on the 3D model OBJ in the space formed within the bounding box BB, so that the processor 130 obtains a plurality of voxels VX1 to VXN corresponding to the supporting member SIA in the space. Further, each of the square lattices in FIG. 2A may represent one of the voxels VX1 to VXN in the space. For ease of description, the scenario of FIG. 2A is described based on implementation of the voxels VX1 to VX5, but the disclosure is not limited thereto. Note that in this embodiment, each of the voxels VX1 to VXN may record that whether the voxel itself includes a portion of the 3D model OBJ. Further, each of the voxels VX1 to VX5 may record related information such as whether a supporting point or a merge point corresponding to the voxel is connected to the 3D model OBJ or the platform 110. As such, in the disclosure, through the voxelization operation performed on the 3D model OBJ located in the space formed within the bounding box BB, in the process of growing the supporting member SIA, the supporting member SIA may effectively keep away from the 3D model OBJ, and time require for searching a growing path is also reduced.

In step S330, the processor 130 may apply related techniques of growing supporting points known to people having ordinary skill in the art to allow a plurality of initial supporting points OSP1 to OSP3 to be generated on the surface of the 3D model OBJ. Next, the processor 130 may generate a plurality of supporting points SP1 to SP3 (also called as first supporting points) according to the initial supporting points OSP1 to OSP3. Herein, the supporting points SP1 to SP3 are located in a normal direction of the surface of the 3D model OBJ. Further, the supporting points SP1 to SP3 are respectively away from the initial supporting points OSP1 to OSP3 by a predetermined distance (e.g., the distance of one voxel, but the disclosure is not limited thereto).

In step S340, the portion selected through box selection by the bounding box BB includes multiple supporting points; nevertheless, only 3 supporting points SP1 to SP3 are depicted in FIG. 2A to act as an exemplary example. Hence, in this embodiment, the processor 130 may select one voxel of the voxels VX1 to VX3 having the supporting points SP1 to SP3 of the supporting points to act as a first voxel. Accordingly, through selecting the voxels VX1 to VX3, the processor 130 may obtain related information recorded in each of the voxels VX1 to VX3, and the processor 130 may plan for a path required to grow the supporting member SIA according to the related information.

In step S350, according to the related information recorded in the selected voxel of the voxels VX1 to VX3 (also call as the first voxel), the processor 130 may determine that a merge point MP1 and a merge point MP2 are located at which voxels of the voxels VX1 to VXN.

Further, in step S350, it is assumed that the processor 130 generates the supporting point SP2 first according to the initial supporting point OSP2. Next, according to the voxel VX2 (also called as a third voxel) at which the supporting point SP2 (also called as a second supporting point) is located, the processor 130 may determine that whether a merge point is present in a first direction of the voxel VX2 (e.g., below the voxel VX2) in the space formed within the bounding box BB. For instance, in an embodiment of the disclosure, when the processor 130 determines that no merge point is present in the first direction of the voxel VX2, the processor 130 searches for voxels in a second direction (e.g., a 45-degree downward direction of the voxel VX2) corresponding to the voxel VX2 in the space. Further, when the processor 130 determines that the voxel VX1 having the supporting point SP1 is present above the voxel VX4, the processor 130 determines to grow the merge point MP1 in the voxel VX4. In other words, the voxel VX4 (also called as a second voxel) is located in the first direction of the voxel VX1 (also called as a fourth voxel) having the supporting point SP1.

From another perspective, when the processor 130 determines that a merge point is present in the first direction of the voxel VX2, the processor 130 instructs the voxel VX2 to search in the first direction so as to determine a position of the voxel corresponding to the merge point.

In addition, when the processor 130 determines that no merge point is present in the first direction of the voxel VX2 and the processor 130 cannot find a voxel of the voxels VX1 to VXN having a merge point in the second direction in the space according to the position of the voxel VX2, the processor 130 then performs step S360.

Note that in another embodiment, it is assumed that the processor 130 generates the supporting point SP2 first according to the initial supporting point OSP2, and the supporting point SP2 is located at an edge adjacent to the bounding box BB, a voxel having a supporting point may be searched according to the position of the supporting point SP2 based on the examples provided by FIG. 2B and FIG. 2C. Specifically, FIG. 2B is a schematic view illustrating a scenario of the 3D printing method according to another exemplary embodiment of the disclosure. Note that FIG. 2C is a schematic view illustrating a process of searching for a voxel having a merge point according to the embodiment of FIG. 2B. Herein, the three-dimensional space of FIG. 2B is depicted based on a side view. FIG. 2C is a top view viewing one layer lower (e.g., a layer L2A) than a layer L1A at which the supporting point SP2 is located in the three-dimensional space.

In the embodiment of FIG. 2B of the disclosure, it is assumed that the processor 130 generates the supporting point SP2 first according to the initial supporting point OSP2. Further, at this time, the voxel VX2 (also called as the third voxel) is located at an edge adjacent to the bounding box BB. The processor 130 may determines that whether a merge point is present in the first direction of the voxel VX2 (e.g., below the voxel VX2) in the space formed within the bounding box BB according to the voxel VX2. When the processor 130 determines that no merge point is present in the first direction of the voxel VX2, the processor 130 downward searches layer by layer (e.g., layers L2A to L3A, and the rest may be deduced by analogy) according to the layer L1A at which the voxel VX2 is located to find whether a voxel having a merge point is present.

Specifically, the voxels of this embodiment are located at multiple layers (e.g., layers L1A to L3A, and the number of the layers are not limited to 3). In FIG. 2B and FIG. 2C, the voxel VX20 located at the layer L2A is located right below the voxel VX2. Further, when the voxel VX2 at which the supporting point SP2 is located is located at the layer L1A and the voxel VX2 is located at an edge adjacent to the bounding box BB at present, the processor 130 may downward searches for voxels having the merge point MP3 (also called as the second merge point) and the merge point MP4 (also called as the third merge point) (not shown) layer by layer (e.g., layers L2A to L3A) according to the layer L1A at which the voxel VX2 is located. Searching for the voxel having the merge point MP3 is taken as an example herein, in the layer L2A, the processor 130 may downward searches a voxel having a merge point layer by layer in extending directions from the voxel VX2 to the voxels VX21 to VX25. For instance, the processor 130 may downward search for a voxel having a merge point layer by layer in the extending direction (e.g., a direction D1) from the voxel VX2 to the voxel VX21. The processor 130 may downward search for a voxel having a merge point layer by layer in the extending direction (e.g., a direction D2) from the voxel VX2 to the voxel VX22. The processor 130 may downward search for a voxel having a merge point layer by layer in the extending direction (e.g., a direction D3) from the voxel VX2 to the voxel VX23. The processor 130 may downward search for a voxel having a merge point layer by layer in the extending direction (e.g., a direction D4) from the voxel VX2 to the voxel VX24. The processor 130 may downward search for a voxel having a merge point layer by layer in the extending direction (e.g., a direction D5) from the voxel VX2 to the voxel VX25. Herein, since the voxels VX26 to VX28 are located at an edge of the bounding box BB, the processor 130 cannot search for voxels having merge points in the extending directions from the voxel VX2 to the voxels VS26 to VX28.

Under such circumstances, in a side view, it is assumed that when the processor 130 determines that a supporting point SPB (also called as a fourth supporting point) is present above a voxel VXB in the direction D3, the processor 130 may generate the merge point MP3 above the voxel VXB in FIG. 2B and FIG. 2C.

Similarly, in the embodiment of FIG. 2B and FIG. 2C, the processor 130 may search for another voxel having the merge point MP4 (not shown) through the same manner. In other words, the processor 130 may also downward search for the voxel having the merge point MP4 layer by layer in at least one of the directions D1 to D5. For instance, in a side view, it is assumed that when the processor 130 determines that a supporting point SPC (not shown, also called as a fifth supporting point) is present above a voxel VXC (not shown) in the direction D4, the processor 130 may generate the merge point MP4 at the voxel VXC in FIG. 2B and FIG. 2C.

In other words, in response to that the processor 130 finds the voxels (e.g., the voxel VXB and the voxel VXC) having the merge point MP3 and the merge point MP4 in the direction D3 and the direction D4 of the voxel VX2, in the following printing process, the processor 130 may instruct the print head 120 to print the first supporting member in the extending direction from the voxel VX2 to the voxel VX23 according to the supporting point SP2 and the merge point MP3. Further, the processor 130 may instruct the print head 120 to print another first supporting member in the extending direction from the voxel VX2 to the voxel VX24 according to the supporting point SP2 and the merge point MP4.

From another perspective, when the processor 130 cannot find the voxels having the merge point MP3 and the merge point MP4 (not shown) in the directions D1 to D5 of the voxel VX2, since the processor 130 cannot find the voxels having the merge point MP3 and the merge point MP4 in at least two directions of the directions D1 to D5 at present, a force provided to support the first supporting members may be insufficient if the processor 130 prints these first supporting members in the direction D3 and the direction D4 of the voxel VX2 in the following printing process. Under such circumstances, the processor 130 may instruct the print head 120 to print the first supporting members in the first direction of the position of the voxel VX2 (e.g., below the voxel VX2) according to the supporting point SP2 in the following printing process. The first supporting members do not include the merge point MP3 nor the merge point MP4.

Note that with reference to FIG. 2A again, in the embodiment of FIG. 2A, the processor 130 determines the merge points according to the supporting points SP1 to SP3 in a random order. For instance, in some embodiments of the disclosure, the processor 130 may search for a merge point according to the supporting point SP2 first, search of a merge point according to the supporting point SP1 next, and finally search for a merge point according to the supporting point SP3. Besides, in some other embodiments of the disclosure, the processor 130 may also search for a merge point according to the supporting point SP1 first, search of a merge point according to the supporting point SP2 next, and finally search for a merge point according to the supporting point SP3. In other words, in several embodiments of the disclosure, the order of searching for the merge points according to the supporting points is not limited to the abovementioned manner.

With reference to the example of FIG. 2A, in step S360, the processor 130 may instruct the print head 120 to print the first supporting member of the supporting members SIA according to the supporting points SP1 to SP2 and the merge point MP1. Herein, the first supporting member consists of a first sub-supporting member SI1, a second sub-supporting member SI2, and a third sub-supporting member SI3. To be specific, a first end of the first sub-supporting member SI1 is connected to the merge point MP1. A first end of the second sub-supporting member SI2 is connected to the first merge point MP1, and a second end of the second sub-supporting member SI2 is connected to the supporting point SP1.

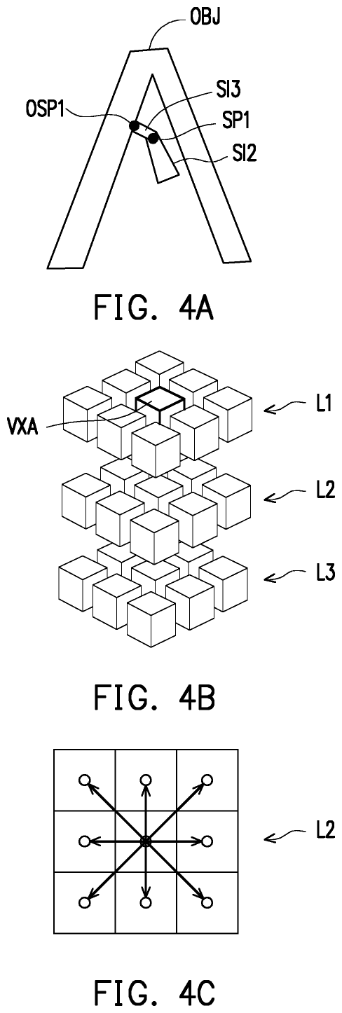

As regards the third sub-supporting member SI3 of the disclosure, with reference to FIG. 1 to FIG. 4A together, FIG. 4A is a schematic view illustrating a third sub-supporting member according to an exemplary embodiment of the disclosure. A first end of the third sub-supporting member SI3 is connected to the second end of the second sub-supporting member SI2, and a second end of the third sub-supporting member SI3 is connected to the initial supporting point OSP1. In other words, in step S360, the processor 130 may print the third sub-supporting member SI3 through the print head 120 according to the normal direction of the surface of the 3D model OBJ from the initial supporting point OSP1, so that the initial supporting point OSP1 may be connected to the supporting point SP1 through the third sub-supporting member SI3. In this way, a contact surface area between the third sub-supporting member SI3 and the 3D model OBJ is effectively reduced in this embodiment. Further, when the processor 130 is required to remove the third sub-supporting member SI3 from the surface of the 3D model OBJ, the surface of the 3D model OBJ is less susceptible to be damaged.

Note that as regards the growing process of connecting the third sub-supporting member SI3 to the second sub-supporting member SI2, with reference to FIG. 4A to FIG. 4C together, FIG. 4B is a schematic view illustrating voxel distribution of the third sub-supporting member according to an exemplary embodiment of the disclosure. Besides, FIG. 4C is a schematic view illustrating a process of searching for voxels of the third sub-supporting member according to an exemplary embodiment of the disclosure. First, in the embodiment of FIG. 4B, the voxels may form a plurality of layers. The layers include, for example, layers L1 to L3, and the layers L1 to L3 are adjacent to one another. It is assumed that the voxel VXA at which the initial supporting point OSP1 is located is located at the layer L1 (also called as a first layer). The processor 130 may determine the supporting point SP1 among the voxels (e.g., the 9 voxels at the layer L2 in FIG. 4C for example) at the layer L2 (also called as a second layer). For instance, the processor 130 may determine that the supporting point SP1 is located at the voxel VX1 at the layer L2. Next, the initial supporting point OSP1 in the voxel VXA may grow the third sub-supporting member SI3 from the layer L1 to the layer L2 in the normal direction of the surface of the 3D model OBJ and allows the third sub-supporting member SI3 to be connected to the supporting point SP1 in the voxel VX1. In this way, the third sub-supporting member SI3 is connected to the second sub-supporting member SI2.

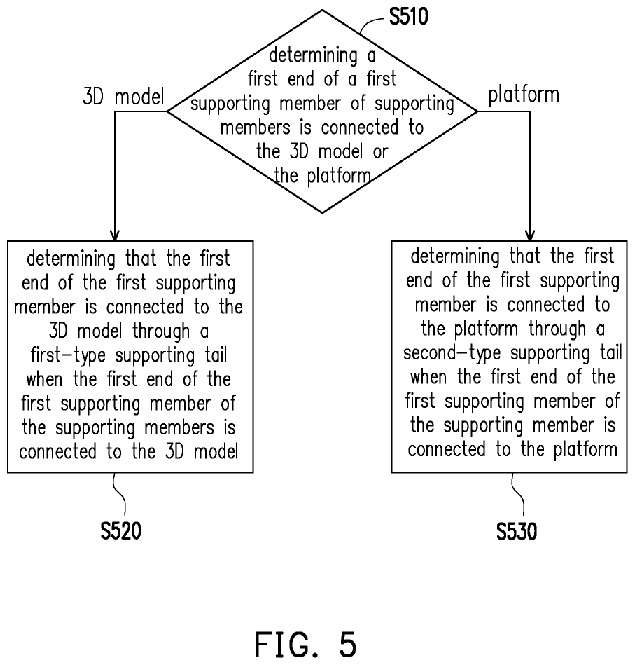

With reference to FIG. 2A and FIG. 5 together for detailed implementation of step S360, FIG. 5 is a flow chart illustrating the 3D printing method according to another exemplary embodiment of the disclosure. In step S510, the processor 130 determines that the first end of the first sub-supporting member SI1 of the supporting member SIA is connected to the 3D model OBJ or the platform 110 first. For instance, in step S520, when the processor 130 determines that the first end of the first sub-supporting member SI1 is connected to the 3D model OBJ, the processor 130 may instruct the print head 120 to print the first-type supporting tail GT1 at the first end of the first sub-supporting member SI1, so that the first sub-supporting member SI1 of the supporting member SIA may be connected to the 3D model OBJ through the first-type supporting tail GT1.

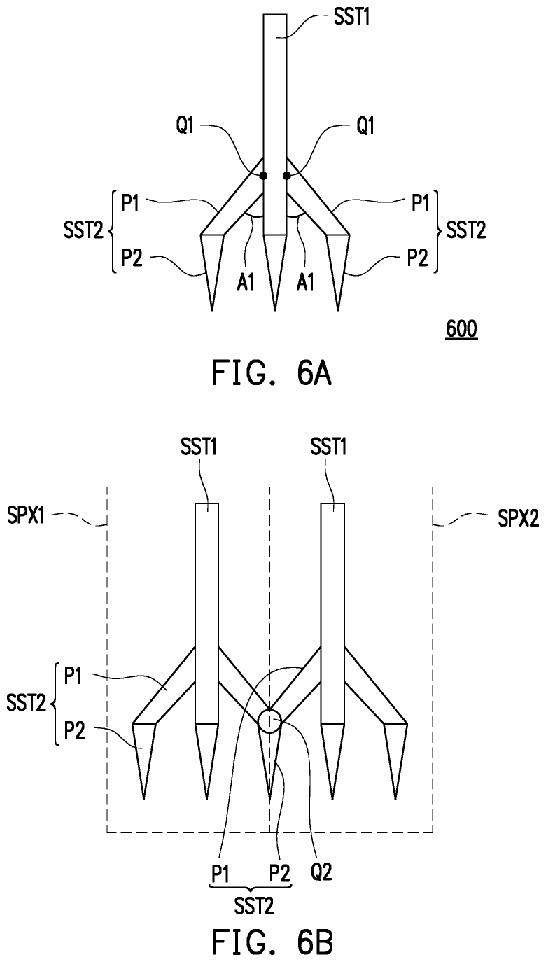

Further, with reference to FIG. 6A as regards a structure of the first-type supporting tail GT1, FIG. 6A is a schematic view of a first-type supporting tail according to an exemplary embodiment of the disclosure. In this embodiment, a first-type supporting tail 600 includes a first sub-supporting tail SST1 and second sub-supporting tails SST2. Herein, the second sub-supporting tails SST2 include first portions P1 and second portions P2. Further, in the first-type supporting tail 600 of this embodiment, the total number of the first sub-supporting tail SST1 and the second sub-supporting tails SST2 may be 3, but the disclosure is not limited thereto. In other embodiments, the first-type supporting tail 600 may include more second sub-supporting tails SST2. From another perspective, in this embodiment, a first end of the first sub-supporting tail SST1 is located in one voxel, and a second end of each of the second portions of each of the second sub-supporting tails SST2 is located in another voxel. In particular, the voxel at which the first end of the first sub-supporting tail SST1 is located and the voxel at which the second end of each of the second portions of each of the second sub-supporting tails SST2 are located are located on a same straight line.

In FIG. 6A, first ends of the first portions P1 are connected to connection points Q1 located on the first sub-supporting tail SST1, so that first angles A1 are included between the first portions P1 and the first sub-supporting tail SST1. Second ends of the first portions P1 are connected to first ends of the second portions P2, and the second ends of the second portions P2 are connected to the surface of the 3D model OBJ. In other words, the second end of the first sub-supporting member SI1 may be connected to the surface of the 3D model OBJ through the first sub-supporting tail SST1. It is worth mentioning that in this embodiment, a direction of the first sub-supporting tail SST1 is identical to the normal direction of the surface of the 3D model OBJ, and a direction of the second portions P2 is identical to the normal direction of the surface of the 3D model OBJ. As such, a pulling force provided by the supporting member SIA on the overall 3D model OBJ may be increased through adopting the first-type supporting tail GT1 for the first sub-supporting member SI1.

From another perspective, in step S530, when the processor 130 determines that the first end of the first sub-supporting member SI1 is connected to the platform 110, the processor 130 may instruct the print head 120 to print the second-type supporting tail GT2 at the first end of the first sup-supporting member SI1, so that the first sub-supporting member SI1 of the supporting member SIA may be connected to the platform 110 through the second-type supporting tail GT2. Herein, the second-type supporting tail GT2 of this embodiment may be, for example, a disk model. That is, when the processor 130 determines that the second end of the first sub-supporting member SI1 is connected to the platform 110, the second end of the first sub-supporting member SI1 may be connected onto the platform 110 through such disk model.

FIG. 6B is a schematic view illustrating the first-type supporting tail according to another embodiment of the disclosure. In another embodiment of the disclosure, the processor 130 may further determines that a first end of a second supporting member SPX2 of the supporting member SIA is connected to the 3D model OBJ through the first-type supporting tail 600. Further, in FIG. 6B, the processor 130 determines that whether the first portion P1 of the second sub-supporting tail SST2 of the first supporting member SPX1 is connected to the first portion P1 of the second sub-supporting tail SST2 of the second supporting member SPX2 at a connection point Q2.

Next, when the processor 130 determines that the first portion P1 of the second sub-supporting tail SST2 of the first supporting member SPX1 is connected to the first portion P1 of the second sub-supporting tail SST2 of the second supporting member SPX2 at the connection point Q2, the processor 130 instructs the print head 120 to print the second portion P2 of the second sub-supporting tail SST2 of the first supporting member SPX1.

In FIG. 6B, the first end of the second portion P2 of the second sub-supporting tail SST2 of the first supporting member SPX1 is connected to the first portion P1 of the second sub-supporting tail SST2 of the first supporting member SPX1 and the first portion P1 of the second sub-supporting tail SST2 of the second supporting member SPX2. Further, the second end of the second portion P2 of the second sub-supporting tail SST2 of the first supporting member SPX1 is connected to the surface of the 3D model OBJ. In other words, in this embodiment, the supporting member SIA may include multiple first-type supporting tails, and the second portions of the second sub-supporting tails of the first-type supporting tails may be mutually shared and connected. In this way, as the supporting points are densely-distributed, the supporting member SIA is prevented from damaging the surface of the 3D model OBJ, and the overall pulling force provided by the supporting member SIA is also increased.

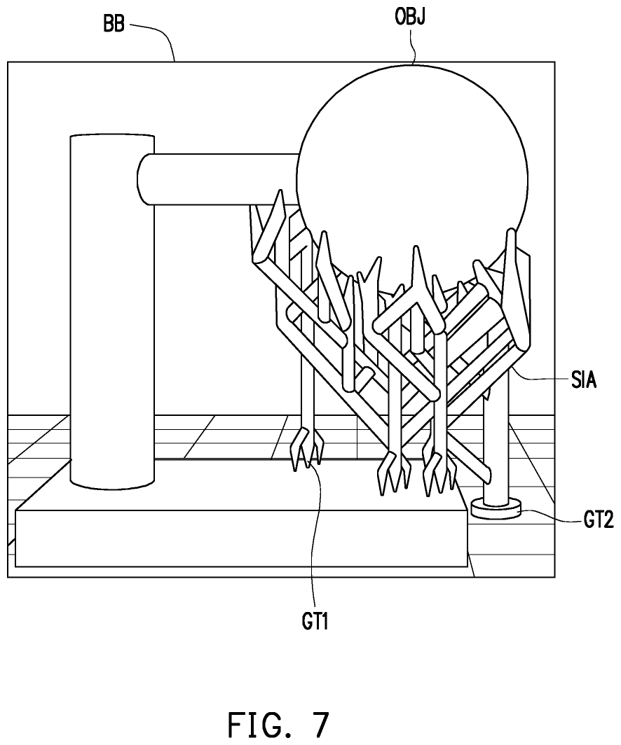

FIG. 7 is a simulation view illustrating a result of 3D printing according to an exemplary embodiment of the disclosure. In this embodiment, the space formed within the bounding box BB includes the 3D model OBJ, the supporting members SIA, the first-type supporting tails GT1, and the second-type supporting tail GT2. Herein, description of each of the components in FIG. 7 and the 3D printing method thereof are described in detail in the implementation of FIG. 1 to FIG. 6, and thus no further description is provided hereinafter.

In view of the foregoing, in the 3D printing method and the 3D printing apparatus provided by the disclosure, voxelization is performed on the space including the 3D model by the processor, so that whether each of the voxels in the space is present in the 3D model is recorded, and other related information such as whether the supporting point of each of the voxels is connected to the 3D model or the platform is also recorded. In this way, in the disclosure, the supporting members may effectively keep away from the 3D model when the supporting members are grown according to the related information. Therefore, time for searching the growing paths is reduced, and 3D printing quality is further enhanced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A three dimensional (3D) printing method for a 3D printing apparatus, the 3D printing apparatus configured to print a 3D model and at least one supporting member which is used to support the 3D model so that the 3D model is formed on a platform, the supporting member connected to at least one supporting point corresponding to the 3D model, the 3D printing method comprising:
performing a voxelization operation on a space comprising the 3D model to obtain a plurality of voxels corresponding to the space;
selecting a first voxel of the voxels comprising a first supporting point of the supporting point;
determining a first merge point of a plurality of merge points according to the first voxel, wherein the first merge point is located in a second voxel of the voxels; and
printing at least one first supporting member of the supporting member according to the first supporting point and the first merge point,
wherein the first supporting member has a first sub-supporting member and a second sub-supporting member, a first end of the first sub-supporting member is connected to the first merge point, a first end of the second sub-supporting member is connected to the first merge point, and a second end of the second sub-supporting member is connected to the first supporting point.

2. The 3D printing method as claimed in claim 1, wherein the first supporting point comprises a second supporting point, wherein the step of determining the first merge point of the merge points according to the first voxel comprises:
determining whether one of the merge points is present in a first direction of a third voxel located in the space according to the third voxel at which the second supporting point is located;
searching for the second voxel in a second direction in the space according to a position of the third voxel and determining the first merge point located in the second voxel when one of the merge points is not present in the first direction of the third voxel located in the space, wherein the second voxel is located in the first direction of a fourth voxel, and the fourth voxel comprises a third supporting point in the first supporting point; and
searching for the second voxel in the first direction according to the position of the third voxel and determining the first merge point located in the second voxel when one of the merge points is present in the first direction of the third voxel located in the space.

3. The 3D printing method as claimed in claim 2, wherein the step of determining whether one of the merge points is present in the first direction of the third voxel located in the space comprises:
performing the step of printing the first supporting member of the supporting member according to the first supporting point and the first merge point when one of the merge points are not present in the first direction of the third voxel located in the space and a fifth voxel having one of the merge points of the voxels is not found in the second direction in the space according to the position of the third voxel.

4. The 3D printing method as claimed in claim 1, wherein the step of printing the first supporting member of the supporting member according to the first supporting point and the first merge point comprises:
determining whether a second end of the first sub-supporting member is connected to the 3D model or the platform;
printing a first-type supporting tail at the second end of the first sub-supporting member so that the first sub-supporting member is connected to the 3D model through the first-type supporting tail when the second end of the first sub-supporting member is connected to the 3D model; and
printing a second-type supporting tail at the second end of the first sub-supporting member so that the first sub-supporting member is connected to the platform through the second-type supporting tail when the second end of the first sub-supporting member is connected to the platform.

5. The 3D printing method as claimed in claim 1, wherein before the step of performing the voxelization operation on the space comprising the 3D model to obtain the voxels corresponding to the space, the method further comprises:
performing bounding box operation on the 3D model so that the 3D model is located in the space formed within the bounding box.

6. The 3D printing method as claimed in claim 1, wherein before the step of selecting the first voxel of the voxels comprising the first supporting point of the supporting point, the method further comprises:
generating the supporting point according to at least one initial supporting point located at a surface of the 3D model, wherein the supporting point is located in a normal direction of the surface, and the supporting point is away from the initial supporting point by a predetermined distance.

7. The 3D printing method as claimed in claim 1, wherein the first supporting member has a third sub-supporting member, a first end of the third sub-supporting member is connected to the second end of the second sub-supporting member, and a second end of the third sub-supporting member is connected to a first initial supporting point of the initial supporting point.

8. The 3D printing method as claimed in claim 7, wherein the voxels form a plurality of layers, a first layer of the layers comprises the voxel at which the first initial supporting point is located, the first voxel is located at a second layer of the layers, and the first layer is adjacent to the second layer.

9. The 3D printing method as claimed in claim 2, wherein the step of searching for the second voxel in the second direction in the space according to the position of the third voxel and determining the first merge point located in the second voxel comprises:
determining whether a second merge point and a third merge point of the merge points are present in at least two of a plurality of extending directions of the position of the third voxel, wherein the second merge point and the third merge point are respectively located in the first direction of a fourth supporting point and a fifth supporting point of the supporting point;
when the second merge point and the third merge point of the merge points are present in at least two of the extending directions of the position of the third voxel, the step of printing the first supporting member of the supporting member according to the first supporting point and the first merge point further comprising:
printing the first supporting member in at least two of the extending directions of the position of the third voxel according to the second supporting point, the second merge point, and the third merge point, wherein the first supporting member comprises the second merge point and the third merge point; and
when the second merge point and the third merge point of the merge points are not present in at least two of the extending directions of the position of the third voxel, the step of printing the first supporting member of the supporting member according to the first supporting point and the first merge point comprising:
printing the first supporting member in the first direction of the position of the third voxel according to the second supporting point, wherein the first supporting member does not comprise the second merge point nor the third merge point.

10. A three dimensional (3D) printing apparatus, comprising:
a platform;
a print head, configured to print a 3D model and at least one supporting member which is used to support the 3D model on the platform, wherein the supporting member is connected to at least one supporting point corresponding to the 3D model; and
a processor, configured to:
perform a voxelization operation on a space comprising the 3D model to obtain a plurality of voxels corresponding to the space,
select a first voxel of the voxels comprising a first supporting point of the supporting point;
determining a first merge point of a plurality of merge points according to the first voxel, wherein the first merge point is located in a second voxel of the voxels, and
control the print head to print at least one first supporting member of the supporting member according to the first supporting point and the first merge point,
wherein the first supporting member has a first sub-supporting member and a second sub-supporting member, a first end of the first sub-supporting member is connected to the first merge point, a first end of the second sub-supporting member is connected to the first merge point, and a second end of the second sub-supporting member is connected to the first supporting point.

11. The 3D printing apparatus as claimed in claim 10, wherein the first supporting point comprises a second supporting point,
the processor is further configured to:
determine whether one of the merge points is present in a first direction of a third voxel located in the space according to the third voxel at which the second supporting point is located,
search for the second voxel in a second direction in the space according to a position of the third voxel and determining the first merge point located in the second voxel when one of the merge points is not present in the first direction of the third voxel located in the space, wherein the second voxel is located in the first direction of a fourth voxel, and the fourth voxel comprises a third supporting point in the first supporting point, and
search for the second voxel in the first direction according to the position of the third voxel and determining the first merge point located in the second voxel when one of the merge points is present in the first direction of the third voxel located in the space.

12. The 3D printing apparatus as claimed in claim 11, wherein the processor is further configured to:
perform the step of printing the first supporting member of the supporting member according to the first supporting point and the first merge point when one of the merge points are not present in the first direction of the third voxel located in the space and a fifth voxel having one of the merge points of the voxels is not found in the second direction in the space according to the position of the third voxel.

13. The 3D printing apparatus as claimed in claim 10, wherein the processor is further configured to:
determine whether a second end of the first sub-supporting member is connected to the 3D model or the platform,
print a first-type supporting tail at the second end of the first sub-supporting member so that the first sub-supporting member is connected to the 3D model through the first-type supporting tail when the second end of the first sub-supporting member is connected to the 3D model, and
print a second-type supporting tail at the second end of the first sub-supporting member so that the first sub-supporting member is connected to the platform through the second-type supporting tail when the second end of the first sub-supporting member is connected to the platform.

14. The 3D printing apparatus as claimed in claim 10, wherein the processor is further configured to:
perform bounding box operation on the 3D model so that the 3D model is located in the space formed within the bounding box.

15. The 3D printing apparatus as claimed in claim 10, wherein the processor is further configured to:
generate the supporting point according to at least one initial supporting point located at a surface of the 3D model, wherein the supporting point is located in a normal direction of the surface, and the supporting point is away from the initial supporting point by a predetermined distance.

16. The 3D printing apparatus as claimed in claim 10, wherein the first supporting member has a third sub-supporting member, a first end of the third sub-supporting member is connected to the second end of the second sub-supporting member, and a second end of the third sub-supporting member is connected to a first initial supporting point of the initial supporting point.

17. The 3D printing apparatus as claimed in claim 16, wherein the voxels form a plurality of layers, a first layer of the layers comprises the voxel at which the first initial supporting point is located, the first voxel is located at a second layer of the layers, and the first layer is adjacent to the second layer.

18. The 3D printing apparatus as claimed in claim 11, wherein the processor is further configured to:
determine whether a second merge point and a third merge point of the merge points are present in at least two of a plurality of extending directions of the position of the third voxel, wherein the second merge point and the third merge point are respectively located in the first direction of a fourth supporting point and a fifth supporting point of the supporting point,
when the second merge point and the third merge point of the merge points are present in at least two of the extending directions of the position of the third voxel, the print head printing the first supporting member in at least two of the extending directions of the position of the third voxel according to the second supporting point, the second merge point, and the third merge point, wherein the first supporting member comprises the second merge point and the third merge point, and
when the processor determines that the second merge point and the third merge point of the merge points are not present in at least two of the extending directions of the position of the third voxel, the print head printing the first supporting member in the first direction of the position of the third voxel according to the second supporting point, wherein the first supporting member does not comprise the second merge point nor the third merge point.

19. A three dimensional (3D) printing method for a 3D printing apparatus, the 3D printing apparatus configured to print a 3D model and at least one supporting member which is used to support the 3D model so that the 3D model is formed on a platform, the supporting member connected to at least one supporting point corresponding to the 3D model, the 3D printing method comprising:
determining whether a first end of a first supporting member of the supporting member is connected to the 3D model or the platform;
determining that the first end of the first supporting member is connected to the 3D model through a first-type supporting tail when the first end of the first supporting member of the supporting member is connected to the 3D model; and
printing the first-type supporting tail at the first end of the first supporting member,
wherein the first-type supporting tail comprises a first sub-supporting tail and a second sub-supporting tail, the second sub-supporting tail comprises a first portion and a second portion, the first sub-supporting tail is connected to a surface of the 3D model, and a direction of the first sub-supporting tail is identical a normal direction of the surface of the 3D model,
a first end of the first portion connected to a connection point located on the first sub-supporting tail so that a first angle is included between the first portion and the first sub-supporting tail, a second end of the first portion connected to a first end of the second portion, a second end of the second portion connected to the surface of the 3D model, a direction of the second portion being identical to the normal direction of the surface of the 3D model.

20. The 3D printing method as claimed in claim 19, the method further comprising:
determining whether a first end of a second supporting member of the supporting member is connected to the 3D model through the first-type supporting tail,
wherein the step of printing the first-type supporting tail at the first end of the first supporting member comprises:
determining whether the first portion of the second sub-supporting tail of the first supporting member is connected to the first portion of the second sub-supporting tail of the second supporting member at a connection point; and
printing the second portion of the second sub-supporting tail of the first supporting member when the first portion of the second sub-supporting tail of the first supporting member is connected to the first portion of the second sub-supporting tail of the second supporting member at the connection point,
wherein the first end of the second portion of the second sub-supporting tail of the first supporting member is connected to the first portion of the second sub-supporting tail of the first supporting member and the first portion of the second sub-supporting tail of the second supporting member, and the second end of the second portion of the second sub-supporting tail of the first supporting member is connected to the surface of the 3D model.

21. The 3D printing method as claimed in claim 19, wherein the voxel at which the first end of the first sub-supporting tail is located and the voxel at which the second end of the second portion of the second sub-supporting tail is located are located on a same straight line.

22. A three-dimensional printing apparatus, comprising:
a platform;
a print head, configured to print a 3D model and at least one supporting member supporting the 3D model on the platform, wherein the supporting member is connected to at least one supporting point corresponding to the 3D model; and
a processor, configured to:
determine whether a first end of a first supporting member of the supporting member is connected to the 3D model or the platform,
determine that the first end of the first supporting member is connected to the 3D model through a first-type supporting tail when the first end of the first supporting member of the supporting member is connected to the 3D model, and
control the print head to print the first-type supporting tail at the first end of the first supporting member,
wherein the first-type supporting tail comprises a first sub-supporting tail and a second sub-supporting tail, the second sub-supporting tail comprises a first portion and a second portion, the first sub-supporting tail is connected to a surface of the 3D model, and a direction of the first sub-supporting tail is identical a normal direction of the surface of the 3D model,
a first end of the first portion connected to a connection point located on the first sub-supporting tail so that a first angle is included between the first portion and the first sub-supporting tail, a second end of the first portion connected to a first end of the second portion, a second end of the second portion connected to the surface of the 3D model, a direction of the second portion being identical to the normal direction of the surface of the 3D model.

23. The 3D printing apparatus as claimed in claim 22, wherein the processor is further configured to:
Determine that a first end of a second supporting member of the supporting member is connected to the 3D model through the first-type supporting tail,
determine whether the first portion of the second sub-supporting tail of the first supporting member is connected to the first portion of the second sub-supporting tail of the second supporting member at a connection point, and
control the print head to print the second portion of the second sub-supporting tail of the first supporting member when the first portion of the second sub-supporting tail of the first supporting member is connected to the first portion of the second sub-supporting tail of the second supporting member at the connection point,
wherein the first end of the second portion of the second sub-supporting tail of the first supporting member is connected to the first portion of the second sub-supporting tail of the first supporting member and the first portion of the second sub-supporting tail of the second supporting member, and the second end of the second portion of the second sub-supporting tail of the first supporting member is connected to the surface of the 3D model.

24. The 3D printing apparatus as claimed in claim 22, wherein the voxel at which the first end of the first sub-supporting tail is located and the voxel at which the second end of the second portion of the second sub-supporting tail is located are located on a same straight line.
